(19) United States
(12) Patent Application Publication
(10) Pub. No.: US 2010/0199580 A1
(43) Pub. Date: Aug. 12, 2010

(54) DOOR FRAME STRUCTURE AND MOUNTING METHOD THEREOF

(76) Inventor: Dong Sub Park, Shiheungi-si (KR)

Correspondence Address: CHRISTOPHER PAUL MITCHELL, 888 16TH ST., NW, SUITE 800, WASHINGTON, DC, 20006, US

(21) Appl. No.: 12/528,624

(22) PCT Filed: May 10, 2007
(86) PCT No.: PCT/KR2007/002309

§ 371 Date: Mar. 25, 2010

(30) Foreign Application Priority Data
Mar. 2, 2007 (KR) 10-2007-0020747

(51) Int. Cl. E06B 1/52; E06B 1/60

(52) U.S. Cl. 52/210; 52/745.15

(57) ABSTRACT

An object of the present invention is to provide a door frame structure that can block light or noise without inconvenience or risk of an accident while a user moves near a door. A door is provided in a middle portion of the door frame in the door frame structure. In order to achieve the above-mentioned object, according to the present invention, a door frame structure includes side covers for covering both side surfaces of a temporary door frame, and a central cover for covering the side covers. A door is fixed to a fixing part having a stepped shape, which is formed in each of the side covers and the central cover, and swings, so that the door is positioned in a middle portion of the door frame. According to the above-mentioned structure of the present invention, a door is positioned in a middle portion of the door frame. Further, a handle and a hinge, which are provided on the outer portion of the door, are positioned inside the door frame. Accordingly, while a user moves near the door, it is possible to prevent a user from being caught by the handle or hinge and to prevent the occurrence of an accident caused by a strong collision.

### TECHNICAL FIELD

The present invention relates to a door frame structure, and more particularly, to a door frame structure where a door is provided in a middle portion of a door frame and a method of mounting the door frame structure. Background Art

In general, when a door is mounted in a multiple dwelling such as an apartment, or a detached dwelling, as shown in FIG. 7, a door D is fixed to a left or right outer end of a door frame in a thickness direction of a wall to which the door is fixed.

For this reason, a handle 1 or a hinge 2, which are provided on the outer portion of the door, protrude from the door frame. As a result, if a user is caught by the handle or hinge or strongly collides against the handle or hinge while moving near the door, there has been a risk that the user is injured.

Further, since the door is fixed to the outer end of the door frame, it is not possible to sufficiently block light or noise through a gap 3 between the door and the door frame.

In addition, since the handle and the hinge are exposed to the outside, a door frame structure does not look fine externally.

### DISCLOSURE OF INVENTION

### Technical Problem

The present invention has been made to solve the above-mentioned problems and it is an object of the present invention to provide a door frame structure where a door is provided in a middle portion of a door frame in the door frame structure. According to the door frame structure, it is possible to block light or noise without inconvenience or risk of an accident while a user moves near a door.

### Technical Solution

In order to achieve the above-mentioned object, according to an aspect of the present invention, a door frame structure includes side covers for covering both side surfaces of a temporary door frame, and a central cover for covering the side covers. In this case, a fixing part having a stepped shape is formed in the central cover so as to be positioned in a middle portion of the door frame, and a door is fixed to the fixing part and swings.

In the door frame structure according to the aspect of the present invention, the height of the fixing part may be smaller than that of the central cover and be larger than those of the side covers at one end of the central cover. Further, a protruding part, which protrudes downward to support the central cover against the side cover, may be formed on the lower surface of the other end of the central cover.

In the door frame structure according to the aspect of the present invention, a supporting part, which protrudes downward to support the fixing part against the temporary door frame, may be formed on the lower surface of the fixing part.

In the door frame structure according to the aspect of the present invention, a concave groove into which a gasket is inserted may be formed on an inner stepped portion of the fixing part.

In the door frame structure according to the aspect of the present invention, a protrusion may be formed on the upper surface of the side cover positioned at the other end of the central cover so as to be positioned inside the protruding part of the central cover when the central cover is assembled.

In the door frame structure according to the aspect of the present invention, the protruding part may further include a second protruding part, which protrudes downward from the protruding part in order to support the central cover against the temporary door frame.

Further, according to another aspect of the present invention, a door frame structure includes side covers for covering both side surfaces of a temporary door frame, and a central cover for covering the side covers. In this case, a fixing part having a stepped shape is formed in the side cover so as to be positioned in a middle portion of the door frame, and a door is fixed to the fixing part and swings.

In the door frame structure according to another aspect of the present invention, the height of the fixing part may be larger than that of the side cover and be smaller than that of central cover at one end, which faces the central cover, of one side cover of the side covers.

In the door frame structure according to another aspect of the present invention, a supporting part, which protrudes downward to support the fixing part against the temporary door frame, may be formed on the lower surface of the fixing part.

Furthermore, according to another aspect of the present invention, a method of mounting the door frame structure includes fixing side covers to a temporary door frame so that the side covers cover both side surfaces of the temporary door frame; fixing a central cover, which has a fixing part to be positioned in a middle of the door frame, to the temporary door frame so that the central cover covers the side covers; and fixing a door to the fixing part so that the door swings.

In addition, according to another aspect of the present invention, a method of mounting the door frame structure includes fixing one side cover to a temporary door frame so that one side cover covers one side surface of the temporary door frame, and fixing the other side cover, which has a fixing part to be positioned in a middle of the door frame, to the temporary door frame so that the other side cover covers the other side surface of the temporary door frame; fixing a central cover so that the central cover covers the side covers; and fixing a door to the fixing part so that the door swings.

### Advantageous Effects

According to the above-mentioned structure of the present invention, a door is positioned in a middle portion of the door frame. Further, a handle and a hinge, which are provided on the outer portion of the door, are positioned inside the door frame. Accordingly, while a user moves near the door, it is possible to prevent a user from being caught by the handle or hinge and to prevent the occurrence of an accident caused by a strong collision.

Further, since a gap between the door and the door frame is formed not outside of the door frame but in a middle portion in the door frame, it is possible to reduce light and noise passing through the gap, and to further improve soundproof efficiency by a gasket provided in a stepped portion.

Furthermore, the door frame structure according to the present invention can be used in all kinds of construction works. Further, even when the existing door frame is remodeled, the only prefabricated door frame cover can be simply detached or attached from/to an existing door frame. Therefore, the door frame structure according to the present invention has excellent construction ability.

In addition, since the handle and hinge are positioned inside the door frame, the door frame structure looks fine externally.

### BRIEF DESCRIPTION OF THE DRAWINGS

FIG. 1 is a perspective view of a door frame structure according to the present invention.

FIG. 2 is a cross-sectional view of a door frame structure according to a first embodiment of the present invention.

FIG. 3 is a cross-sectional view of another example of a second cover in the door frame structure according to the first embodiment of the present invention.

FIG. 4 is a cross-sectional view of a structure where a door of the first embodiment of the present invention is fixed.

FIG. 5 is a cross-sectional view of a door frame structure according to a second embodiment of the present invention.

FIG. 6 a cross-sectional view of a door frame structure according to a third embodiment of the present invention.

FIG. 7 is a view of a conventional door frame structure.

### BEST MODE FOR CARRYING OUT THE INVENTION

Preferred embodiments of the present invention will be described below with reference to accompanying drawings.

### First Embodiment

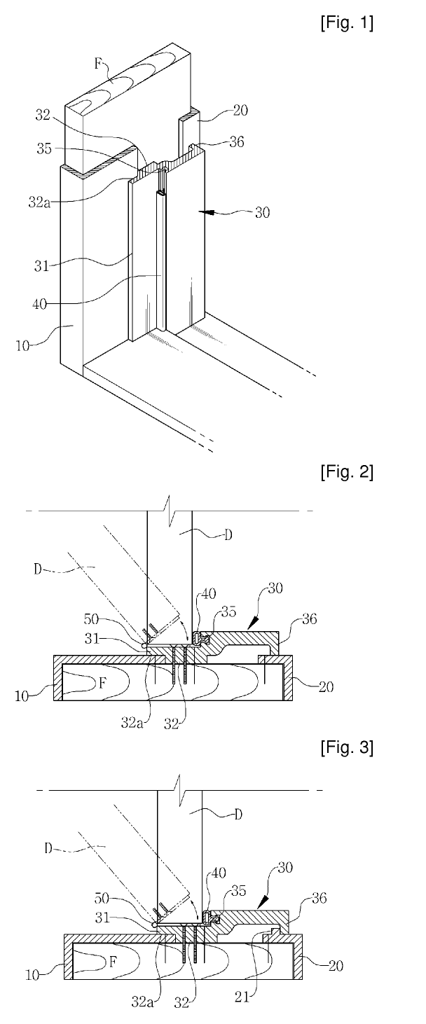

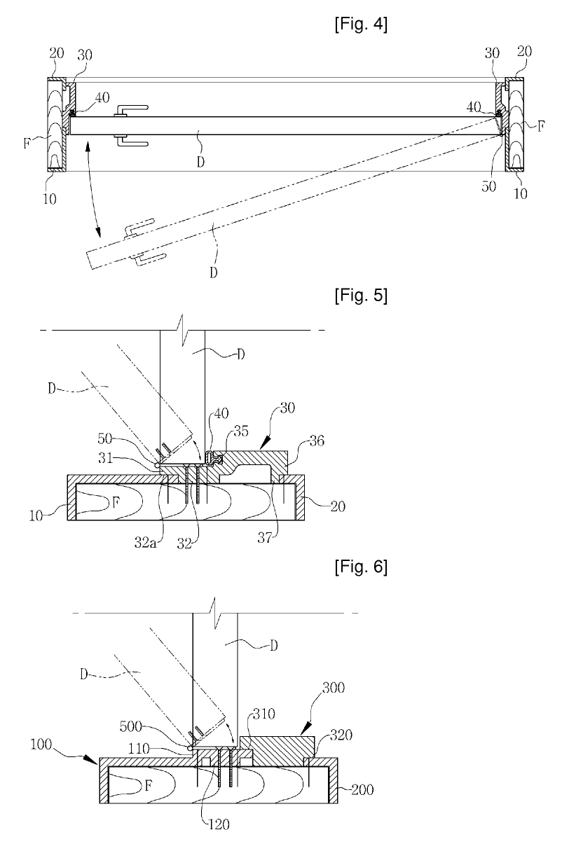

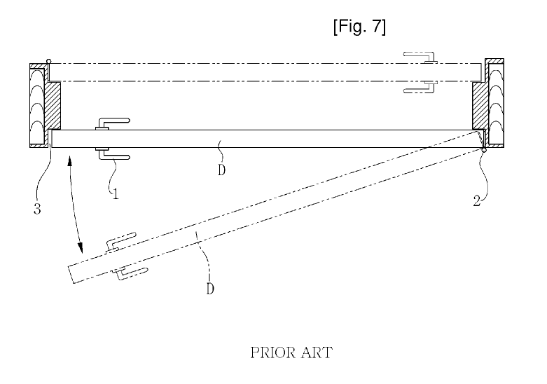

FIG. 1 is a perspective view of a door frame structure according to the present invention. FIG. 2 is a cross-sectional view of a door frame structure according to a first embodiment of the present invention. FIG. 3 is a cross-sectional view of another example of a second cover in the door frame structure according to the first embodiment of the present invention. FIG. 4 is a cross-sectional view of a structure where a door of the first embodiment of the present invention is fixed.

A door frame structure according to the first embodiment includes a first cover 10 for covering one side surface of a temporary door frame F, a second cover 20 that is provided at a side opposite to the first cover and covers the other side surface of the temporary door frame F, and a central cover 30 for partially covering the first and second covers 10 and 20.

Each of the first and second covers 10 and 20 has an L shape, and is composed of a horizontal part and a vertical part connected to the horizontal part. The horizontal part covers an upper surface of the temporary door frame F. The vertical part covers a side surface of the temporary door frame F and extends to a lower end of the side surface of the temporary door frame F.

A protrusion 21 may be formed on the upper surface of the second cover 20 if necessary so as to facilitate the positioning of the central cover 30 during the assembly of the central cover 30. When the assembly of prefabricated door frame covers has been completed, the protrusion 21 is positioned inside the central cover 30 as shown in FIG. 3.

A fixing part 31 is formed on one side surface of the central cover 30.

The fixing part 31 horizontally extends from the central cover 30 toward the first cover 10, and has a stepped shape so that a height of the fixing part 31 is smaller than that of the central cover 30 and larger than those of the first and second covers 10 and 20.

When the assembly of a prefabricated door frame has been completed, the fixing part 31 is positioned substantially in a middle of the door frame. A supporting part 32, which supports the central cover 30 against the temporary door frame F and protrudes downward to fix a hinge 50, is formed on the lower surface of the fixing part 31.

The horizontal part of the first cover 10 is inserted into a groove 32a, which is defined by the lower surface of the fixing part 31 and the supporting part 32.

A concave groove 35 into which a gasket 40 is inserted is formed on the side surface, which is adjacent to the fixing part 31, of the central cover 30.

A protruding part 36, which protrudes downward to support the central cover 30 against the horizontal part of the second cover 20, is formed at the end of the central cover 30 opposite to the concave groove 35.

A method of mounting the door frame structure according to the first embodiment will be described below.

First, the first and second covers 10 and 20 are fixed to both side surfaces of the temporary door frame F by using tacking means. Nails or the like are fixed to portions, which is to be covered with the central cover 30, by using the tacking means. Accordingly, the nails or the like are not seen from the outside.

Further, since the first and second covers 10 and 20 are separately mounted on the temporary door frame, the door frame covers can be mounted on the temporary door frame so as to cover the both side surfaces of the temporary door frame irrespective of the size of the temporary door frame or the width of a wall to which the door frame covers are fixed.

Then, the central cover 30 is positioned so as to partially cover the first and second covers 10 and 20, and is fixed to the temporary door frame F by using the tacking means or the like. After fixing means such as nails used to fix the central cover 30 are fixed beneath the gasket 40 to be inserted, the gasket 40 is inserted into the concave groove 35. Accordingly, it is possible to fix the nails or the likes without being seen from the outside.

When the central cover 30 is positioned, the end of the supporting part 32 facing the first cover 10 may be supported by the end of the horizontal part of the first cover 10. Accordingly, the end of the supporting part 32 facing the first cover 10 can be used to correctly position the central cover 30. Alternatively, the central cover 30 may be moved to right or left side if necessary so that the fixing part 31 is appropriately positioned in the middle of the door frame.

If the protrusion 21 is formed on the second cover 20, it is possible to more correctly and easily position the central cover 30 by using the protrusion 21.

After that, one part of the hinge 50 is fixed to the fixing part 31 by bolts that pass through the fixing part 31 of the central cover 30 and the supporting part 32, and the other part of the hinge 50 is also fixed to a door D by bolts.

Since the door D is fixed to the fixing part 31 of the central cover 30 positioned substantially in the middle portion of the temporary door frame F as described above, the door is positioned in the middle portion of the temporary door frame F.

As shown in the right side of FIG. 4, the above-mentioned structure relates to a door fixing frame structure where the door D is fixed. Further, as shown in the left side of FIG. 4, a door supporting frame structure having the same structure as the door fixing frame structure is also provided to the door frame facing the stationary door frame in order to support the door D.

The same door frame as that of the door fixing frame structure is provided to the door supporting frame structure. However, the door supporting frame structure is different from the door fixing frame structure only in that the end of the door D is not fixed to a fixing part 31 and is supported by the fixing part 31 having a stepped shape so that the rotation of the door is limited.

According to the above-mentioned structure, a handle and a hinge, which are to be generally exposed to the outside of the door frame, are positioned inside the door frame. Accordingly, it is possible to prevent a user being caught by the handle or hinge while the user moves, or to prevent the occurrence of an accident caused by a strong collision.

Further, since a gap between the door and the door frame is also formed in the middle portion inside the door frame, it is possible to reduce light and noise passing through the gap. In particular, since gaskets are provided at stepped portions adjacent to the portions where a door is fixed and supported, it is possible to further reduce light and noise and to absorb the shock caused by a door.

Furthermore, the door frame structure has excellent alterability. Accordingly, the door frame structure can be used irrespective of the change in the width of the door frame, which is changed depending on the thickness of a wall. In addition, when the door frame structure is mounted, it is unnecessary to use protective members for preventing the damage of the door frame.

### Mode for the Invention

### Second Embodiment

FIG. 5 is a cross-sectional view of a door frame structure according to a second embodiment of the present invention.

A door frame structure according to a second embodiment is basically the same as that according to the first embodiment. However, the door frame structure according to the second embodiment is different from the door frame structure according to the first embodiment only in that the door frame structure according to the second embodiment further includes a second protruding part 37 at an inner portion of the end of the protruding part 36 of the central cover 30. The second protruding part 37 protrudes downward from the protruding part 36 in order to support the central cover 30 against the temporary door frame F.

According to the second embodiment, when the door frame structure is mounted, the second supporting part 37 formed in the central cover 30 is supported by the end of the horizontal part of the second cover 20. Accordingly, it is possible to correctly position the central cover 30.

### Third embodiment

A door frame structure according to a third embodiment will be described below with reference to a drawing. FIG. 6 a cross-sectional view of a door frame structure according to a third embodiment of the present invention.

A door frame structure according to a third embodiment is basically the same as the door frame structures according to the first and second embodiments in that a door frame structure includes a first cover 100 for covering one side surface of a temporary door frame F, a second cover 200 that is provided at a side opposite to the first cover and covers the other side surface of the temporary door frame, and a central cover 300 for partially covering the first and second covers 100 and 200.

However, the door frame structure according to the third embodiment is different from the door frame structures according to the first and second embodiments in that a fixing part used to fix or support the door is attached to not the central cover 300 but the first cover 100.

That is, the first cover 100 is composed of vertical and horizontal parts, which cover one side surface of the temporary door frame F, and the fixing part 110 having a stepped shape is connected to the free end of the horizontal part.

The height of the fixing part 110 is larger than the height of the horizontal part of each of the first and second covers 10 and 20, and is smaller than the height of the central cover 300. When the assembly of the door frame structure has been completed, the fixing part 110 is positioned substantially in the middle of the door frame. A supporting part 120 protrudes from the lower surface of the fixing part 110 toward the temporary door frame F.

The second cover 200 has an L shape, and is composed of horizontal and vertical parts for covering the side surface of the temporary door frame F.

A first receiving groove 310 for receiving the fixing part 110 of the first cover 100 is formed on one side of the central cover 300. Further, a second receiving groove 320, which receives the second cover 200 and has a depth smaller than that of the first receiving groove 310, is formed on the other side of the central cover 300.

The door frame structure according to the third embodiment is different from the door frame structures according to the first and second embodiments only in that a portion to which a door D is fixed is formed in not the central cover but the fixing part of the first cover. The door frame structure according to the third embodiment has the same operation as the door frame structures according to the first and second embodiments.

According to the third embodiment, the fixing part has been formed in the first cover. However, the present invention is not limited thereto, and it is apparent that the fixing part may be formed in the second cover.

### INDUSTRIAL APPLICABILITY

Since a door is provided in the middle portion of the door frame in a door frame structure according to the present invention, the door frame structure looks fine externally and can reduce light and noise without the risk of an accident. Therefore, the door frame structure is useful in the building material industry.

1. A door frame structure comprising:
side covers for covering both side surfaces of a temporary door frame; and
a central cover for covering the side covers,
wherein a fixing part having a stepped shape is formed in the central cover so as to be positioned in a middle portion of the door frame, and
a door is fixed to the fixing part and swings.

2. The door frame structure according to claim 1, wherein the height of the fixing part is smaller than that of the central cover and is larger than those of the side covers at one end of the central cover, and a protruding part, which protrudes downward to support the central cover against the side cover, is formed on the lower surface of the other end of the central cover.

3. The door frame structure according to claim 1, wherein a supporting part, which protrudes downward to support the fixing part against the temporary door frame, is formed on the lower surface of the fixing part.

4. The door frame structure according to claim 1, wherein a concave groove into which a gasket is inserted is formed on an inner stepped portion of the fixing part.

5. The door frame structure according to claim 2, wherein a protrusion is formed on the upper surface of the side cover positioned at the other end of the central cover so as to be positioned inside the protruding part of the central cover when the central cover is assembled.

6. The door frame structure according to claim 2, wherein the protruding part further includes a second protruding part, which protrudes downward from the protruding part in order to support the central cover against the temporary door frame.

7. A door frame structure comprising:
side covers for covering both side surfaces of a temporary door frame; and
a central cover for covering the side covers,
wherein a fixing part having a stepped shape is formed in the side cover so as to be positioned in a middle portion of the door frame, and
a door is fixed to the fixing part and swings.

8. The door frame structure according to claim 7, wherein the height of the fixing part is larger than that of the side cover and is smaller than that of central cover at one end, which faces the central cover, of one side cover of the side covers.

9. The door frame structure according to claim 7, wherein a supporting part, which protrudes downward to support the fixing part against the temporary door frame, is formed on the lower surface of the fixing part.

10. A method of mounting the door frame structure according to claim 1, the method comprising:
fixing side covers to a temporary door frame so that the side covers cover both side surfaces of the temporary door frame;
fixing a central cover, which has a fixing part to be positioned in a middle of the door frame, to the temporary door frame so that the central cover covers the side covers; and
fixing a door to the fixing part so that the door swings.

11. A method of mounting the door frame structure according to claim 7, the method comprising:
fixing one side cover to a temporary door frame so that one side cover covers one side surface of the temporary door frame, and fixing the other side cover, which has a fixing part to be positioned in a middle of the door frame, to the temporary door frame so that the other side cover covers the other side surface of the temporary door frame;
fixing a central cover so that the central cover covers the side covers; and
fixing a door to the fixing part so that the door swings.
